(19) United States
(12) Patent Application Publication
(10) Pub. No.: US 2011/0283988 A1
(43) Pub. Date: Nov. 24, 2011

(54) BARBECUE

(75) Inventors: Martin Robert Gaze, Surrey (GB); Terence William Gander, Berkshire (GB); Angus Davidson, Surrey (GB)

(73) Assignee: PLUM PRODUCTS LTD., Horsell, Woking, Surrey (GB)

(21) Appl. No.: 13/002,256

(22) PCT Filed: Jul. 3, 2009
(86) PCT No.: PCT/GB2009/001673

§ 371 Date: Aug. 17, 2011

(30) Foreign Application Priority Data
Jul. 3, 2008 (GB) 0812177.4

(51) Int. Cl. A47J 37/07

(52) U.S. Cl. 126/25 A; 126/9 R

(57) ABSTRACT

A portable barbecue has generally planar front and rear panels hingedly coupled together at their lower ends and openable to form a generally V-sectioned trough. A grill is mountable between the front and rear panels to support food to be cooked by heating elements selected from solid fuel, gas burners and electric elements and located beneath the grill in the trough. A stand is adapted to support the trough above a support surface. The stand has front and rear legs at each end of the trough. These legs are hingedly connected at their upper ends and adapted to be opened out to form an inverted V configuration. The legs are hingedly coupled to ends of the front and rear panels at positions below the hinged connection between the legs and above the hinged connection between the front and rear panels so that the panels and legs can open and close together in lazy-tongs fashion.

### BACKGROUND

This disclosure relates to barbecues.

Barbecues may be provided as permanent structures for grilling food out of doors or as portable structures to be brought out when the weather permits. Most such portable barbecues are substantial wheeled structures that pose a storage problem when not being used.

The present disclosure adopts a different approach aimed to allow the barbecue to be stored in a minimum of space when not required.

### SUMMARY OF THE DISCLOSURE

In accordance with one aspect of the present disclosure, there is provided a portable barbecue comprising: generally planar front and rear panels hingedly coupled together at their lower ends and openable to form a generally V-sectioned trough; a grill mountable between the front and rear panels to support food to be cooked by heating elements selected from solid fuel, gas burners and electric elements and located beneath the grill in the trough; and a stand adapted to support the trough above a support surface, the stand comprising front and rear legs at each end of the trough, hingedly connected at their upper ends and adapted to be opened out to form an inverted V configuration, the legs being hingedly coupled to ends of the front and rear panels at positions below the hinged connection between the legs and above the hinged connection between the front and rear panels so that the panels and legs can open and close together in lazy-tongs fashion.

Preferred embodiments have one or more of the following features: The front legs are connected together, and the rear legs are connected together. A generally V-shaped panel is inserted in the gap between the front and rear panels at each end of the trough. The heating elements comprise solid fuel adapted to be supported on a second smaller grill located beneath the first mentioned grill for food, the space below the second grill in the trough serving as an ash collector, and the V-shaped panels being apertured to allow ingress of air below the second grill to aid combustion of the solid fuel.

### BRIEF DESCRIPTION OF THE DRAWINGS

A preferred embodiment of barbecue is described below by way of example only with reference to the accompanying drawings, in which:

FIG. 1 is an overall perspective view of a barbecue;

FIG. 2 is a top plan view of the barbecue of FIG. 1;

FIG. 3 is a front elevation of the barbecue of FIGS. 1 and 2; and

FIG. 4 is an end elevation of the barbecue of FIGS. 1 to 3.

### DESCRIPTION OF PREFERRED EMBODIMENTS

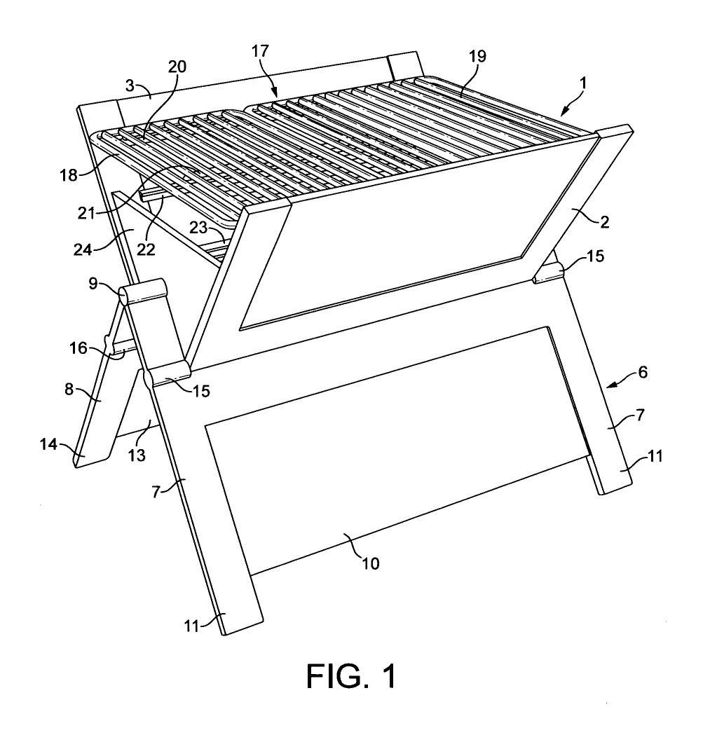

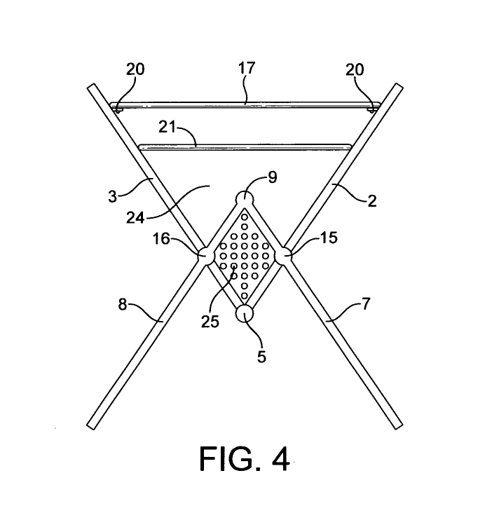

As clearly shown in FIGS. 1 and 4, the illustrated embodiment of barbecue is of generally V-shaped trough form supported on a stand of inverted V configuration.

The trough 1 is formed by a front panel 2 and a rear panel 3 hingedly connected at their lower ends 5. The stand 6 is formed by front 7 and rear 8 legs at each end of the trough 1, the legs being hingedly connected at their upper ends 9. As shown in FIGS. 1 and 3, in this embodiment the front legs 7 are connected together to form a front stand panel 10 with feet 11, and the rear legs are similarly connected together to form a rear stand panel 13 with feet 14, but this is not necessary. However, so that the stand and trough may open and collapse together in lazy-tongs fashion, each front leg is hingedly connected to the front panel at a pivot point 15 at a position beneath the hinged connection at 9 between the front and rear legs and above the hinged connection at 5 between the front and rear panels, and similarly each rear leg is hingedly connected to the rear panel at a pivot point 16 at a position beneath the hinged connection at 9 between the front and rear legs and above the hinged connection at 5 between the front and rear panels.

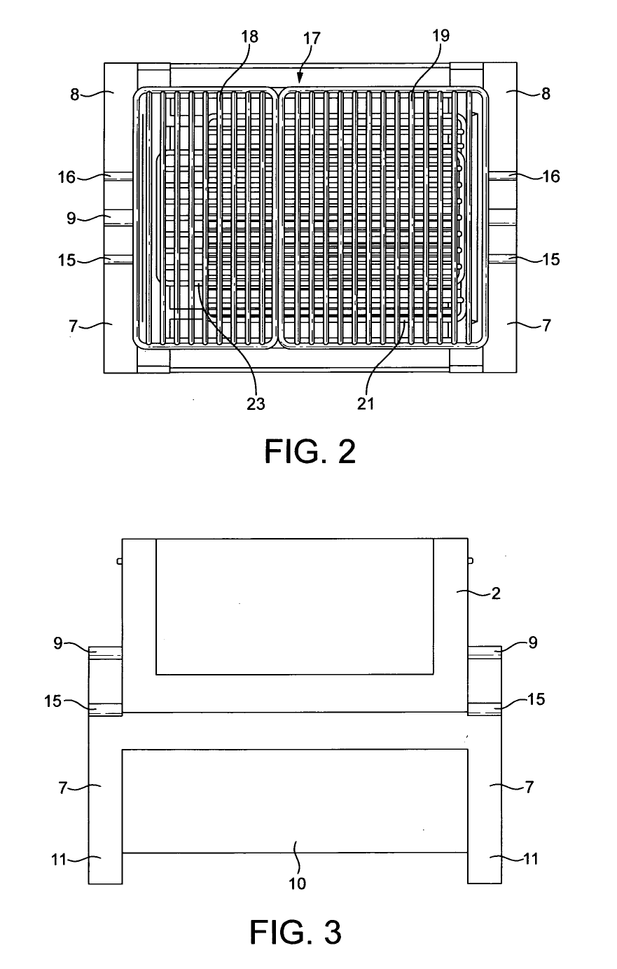

Trough 1 supports grills for food to be cooked at two levels. A top wire grill 17 is formed in two sections 18 and 19 and supported on ledges 20 formed on the front and rear panels. A lower grill 21 is similarly supported on ledges 22. At a third level below the lower grill, a further grill 23 is supported by the front and rear panels for solid fuel, ash from the burning fuel falling into the bottom of the trough. As can be seen in FIGS. 1 and 2, in the illustrated arrangement, the grill wires of top grill 19 extend across the barbecue from front panel 2 to rear panel 3, while the grill wires of lower grill 21 extend along the barbecue in the direction from one end of the trough towards the other. By selection of the dimensions of top grill 19 and of lower grill 21, and positioning of ledges 20 and 22, the same grill may serve both as a top grill 19 and as a lower grill 22, simply needing to be turned through a right angle from one orientation to the other depending on the use to which it is to be put.

V-shaped panels 24, preferably inserted into grooves in the front and rear panels, close off the lower portion of the trough at either end thereof. The V-panels are preferably apertured, as shown at 25, to ensure adequate air for combustion.

It will be appreciated that, in alternative embodiments, the solid fuel grill 23 may be replaced with a gas burner or an electric heating element.

One of the grills is suitably hooked to both the front and rear panels to ensure stability of the lazy tongs structure of trough and stand when open.

1. A portable barbecue comprising: generally planar front and rear panels hingedly coupled together at their lower ends and openable to form a generally V-sectioned trough; a grill mountable between the front and rear panels to support food to be cooked by heating elements selected from solid fuel, gas burners and electric elements and located beneath the grill in the trough; and a stand adapted to support the trough above a support surface, the stand comprising front and rear legs at each end of the trough, hingedly connected at their upper ends and adapted to be opened out to form an inverted V configuration, the legs being hingedly coupled to ends of the front and rear panels at positions below the hinged connection between the legs and above the hinged connection between the front and rear panels so that the panels and legs can open and close together in lazy-tongs fashion.

2. A barbecue according to claim 1, wherein the front legs are connected together, and the rear legs are connected together.

3. A barbecue according to claim 1, further comprising two generally V-shaped panels adapted to be inserted in the gap between the front and rear panels at each end of the trough when opened.

4. A barbecue according to claim 3, wherein the heating elements comprise solid fuel adapted to be supported on a second smaller grill located beneath the first mentioned grill for food, the space below the second grill in the trough serving as an ash collector, and the V-shaped panels being apertured to allow ingress of air below the second grill to aid combustion of the solid fuel.

5. A barbecue according to claim 1, wherein the front and rear panels are provided with positioning elements defining two different levels for supporting a grill above the heating elements, and wherein the grill is formed as two grill members of the same length and different widths, the two grill members being adapted to sit alongside each other at the upper of said levels with their lengths extending from the front to the rear panel, and the width of one said grill member being chosen so that it may be supported at the lower of said levels with its width extending from the front to the rear panel.
